(19) United States
(12) Patent Application Publication
(10) Pub. No.: US 2025/0182037 A1
(43) Pub. Date: Jun. 5, 2025

(54) METHOD AND DEVICE FOR PROCESSING SHIPMENT IN THIRD PARTY SHIPPING SERVICE

(71) Applicant: COLOSSEUM CORPORATION, INC., Seoul (KR)

(72) Inventor: Jinsu PARK, Seoul (KR)

(21) Appl. No.: 18/398,004

(22) Filed: Dec. 27, 2023

(30) Foreign Application Priority Data
Dec. 1, 2023 (KR) 10-2023-0172278

(51) Int. Cl. G06Q 10/0833

(52) U.S. Cl. CPC G06Q 10/0833

(57) ABSTRACT

A method and device for processing shipment in a third party shipping service is proposed. The proposed relates to a method for processing shipment in a third party shipping service and a device for executing the method. The method includes verifying a shipment application received from a terminal device of a seller, providing status information of a product warehoused at a third party shipping facility to the terminal device of the seller, receiving volume and weight inspection information of the warehoused product from a terminal device of a third party shipping service provider, and providing status information of the product shipped from the third party shipping facility to the terminal device of the seller.

### CROSS REFERENCE TO RELATED APPLICATION

The present application claims priority to Korean Patent Application No. 10-2023-0172278, filed Dec. 1, 2023, the entire contents of which are incorporated herein for all purposes by this reference.

### BACKGROUND OF THE INVENTION

### Field of the Invention

The present disclosure relates to a method for processing shipment in a third party shipping service and a device for executing the method.

More particularly, the present disclosure relates to a method configured to verify a shipment application prepared by a product seller, provide status information of products warehoused at a third party shipping facility, manage inspection information, and provide status information of the products shipped from the third party shipping facility, and relates to a device for executing the method.

### Description of the Related Art

Since the end of the 20th century, as personal computers have become widely available and high-speed communication networks have been established, various Internet services using such technologies have developed. In particular, product order quantities and product delivery volumes via online commerce is increasing every year. Furthermore, the number of cases where purchasing products or providing services non-face-to-face is gradually increasing due to the coronavirus-19 infection that spread in year 2020. Accordingly, not only B2C logistics volume, but also B2B logistics volume is in fact increasing every year.

In addition, usage of third party shipping services is also increasing, wherein in a case where direct delivery to a country is not available when a product is purchased online from overseas, the product is firstly delivered to a third party shipping facility located overseas and then secondarily delivered from the third party shipping facility to a domestic address of the country.

In a third party shipping service, not only a product buyer residing in a country may use a third party shipping facility located overseas to receive a delivered product, but also a product seller operating in the country may use a third party shipping facility located domestically or overseas when delivering a product to a product buyer residing overseas.

In the third party shipping service, a third party shipping service provider inspects a product that has arrived at a third party shipping facility, and then a transportation company delivers the product to an address specified by a product buyer.

However, there may occur a problem that a product is undeliverable due to an incorrect address specified by a product buyer or due to local circumstances. In addition, when products in large quantities are shipped, the third party shipping service provider may have errors that occur frequently while inspecting the products that have arrived at a third party shipping facility.

Accordingly, there are problems which may occur such that the purchased products are not delivered from the third party shipping facility to designated addresses specified by product buyers, the purchased products are delivered to places other than the designated addresses, deliveries are delayed, or some purchased products are missing, thereby causing damage to consumers using the third party shipping service.

### DOCUMENTS OF RELATED ART

### [Patent Document]

Korean Patent Application Publication No. 10-2023-0059701

### SUMMARY OF THE INVENTION

An objective of the present disclosure is to solve the above-described problems, provide a method configured to verify a shipment application prepared by a product seller, provide status information of products warehoused at a third party shipping facility, manage inspection information, and provide status information of the products shipped from the third party shipping facility, and is to provide a device for executing the method.

According to an exemplary embodiment of the present disclosure in order to achieve the objective as described above, there is provided a method for processing shipment in a third party shipping service, the method including: verifying a shipment application received from a terminal device of a seller; providing status information of a product warehoused at a third party shipping facility to the terminal device of the seller; receiving volume and weight inspection information of the warehoused product from a terminal device of a third party shipping service provider; and providing status information of the product shipped from the third party shipping facility to the terminal device of the seller.

In the exemplary embodiment, the shipment application may include a plurality of pieces of delivery product information.

In the exemplary embodiment, the verifying of the shipment application may check whether designated items among an item classification code, a delivery address, a country of the delivery address, a unit price, and a transaction code are input into the delivery product information.

In the exemplary embodiment, the verifying of the shipment application may check whether a delivery address is an address from a place that does not exist or a place where delivery is unavailable, and whether a country of the delivery address is a country that does not exist or a country where the delivery is unavailable.

In the exemplary embodiment, in the verifying of the shipment application, the terminal device of the seller may transmit the delivery product information to a verification module and then disconnect a connection to the verification module, the verification module may verify the received delivery product information and transmits a verification result to a service module, and the service module may transmit the verification result received by the service module to the terminal device of the seller in response to querying the service module for the verification result at regular intervals.

In the exemplary embodiment, the verification module may transmit an event or a trigger to a computing resource of a cloud service, the computing resource of the cloud service may be operated by the event or the trigger and then verify the delivery product information, and the computing resource of the cloud service may complete the verification of the delivery product information, transmit the verification result to the service module, and then terminate an operation thereof.

In the exemplary embodiment, the status information of the warehoused product may include one or more of progress status, a stock number, the number of deliveries, the number of invoice outputs, a shipment type, an expected warehousing date, a product warehousing method, and request details of the seller.

In the exemplary embodiment, the receiving of the volume and weight inspection information of the warehoused product may provide volume and weight information of the product having a product code same as a product code scanned by the terminal device of the third party shipping service provider.

In the exemplary embodiment, the status information of the shipped product may include one or more of whether an invoice is printed or not, shipment progress status, whether inspection is completed or not, an order number, a transportation company name, an invoice number, a delivery address, a country code of the delivery address, and a recipient name.

In the exemplary embodiment, invoice generation may be requested from a transportation management system, invoice information may be received from the transportation management system, and the invoice information may be processed and transmitted to the terminal device of the third party shipping service provider.

According to another exemplary embodiment of the present disclosure, there is provided a device for processing shipment in a third party shipping service, wherein a shipment application received from a terminal device of a seller is verified, status information of a product warehoused at a third party shipping facility is provided to the terminal device of the seller, volume and weight inspection information of the warehoused product is received from a terminal device of a third party shipping service provider; and status information of the product shipped from the third party shipping facility is provided to the terminal device of the seller.

In the embodiments of the present disclosure, a shipment application prepared by a product seller may be verified, thereby preventing problems which may occur during delivery such that products are not delivered to delivery addresses, products are delivered to places other than the designated addresses, or deliveries are delayed.

In addition, a seller may request shipment regardless of when products are warehoused, product delivery status (i.e., before product warehousing at a third party shipping facility, during the product warehousing, completion of the product warehousing, during shipment from the third party shipping facility, completion of the shipment, during delivering by a transportation company, completion of the delivery, etc.) may be checked regardless of whether the products are warehoused at the third party shipping facility or are inspected and shipped from the third party shipping facility, thereby enabling the seller to inquire about shipment details conveniently at any time the products are delivered.

In addition, status information about products which are warehoused at a third party shipping facility or products which are shipped from the third party shipping facility are provided, thereby enabling a seller and a third party shipping service provider to use the product status information conveniently.

In addition, inspection information of products which are warehoused at a third party shipping facility may be automatically recorded, thereby preventing a problem that the products may be omitted due to incorrect input of the volume and weight information of the products.

### BRIEF DESCRIPTION OF THE DRA WINGS

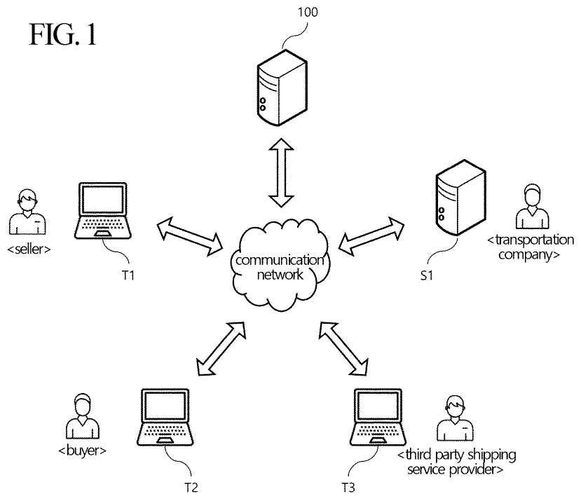

FIG. 1 is a view briefly illustrating a device and other components for processing shipment in a third party shipping service according to an exemplary embodiment of the present disclosure.

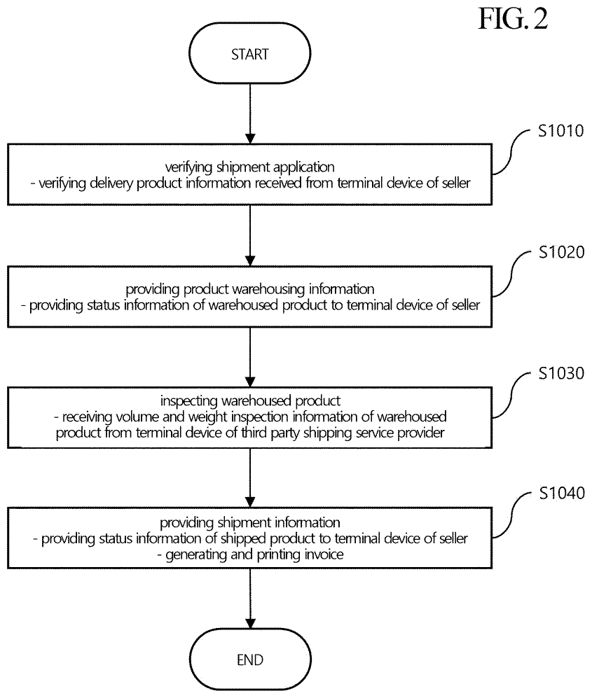

FIG. 2 is a flowchart illustrating a method for processing shipment in a third party shipping service according to the exemplary embodiment of the present disclosure.

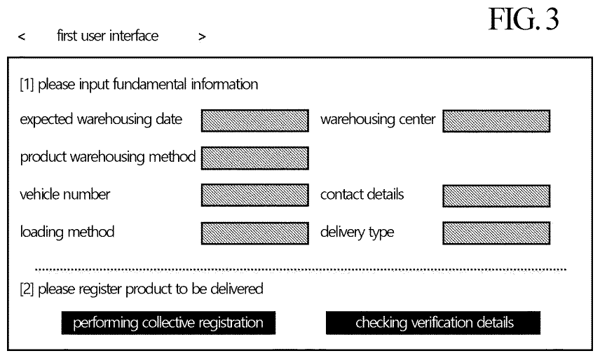

FIG. 3 is a view illustrating a first user interface when a seller submits a shipment application in the exemplary embodiment of the present disclosure.

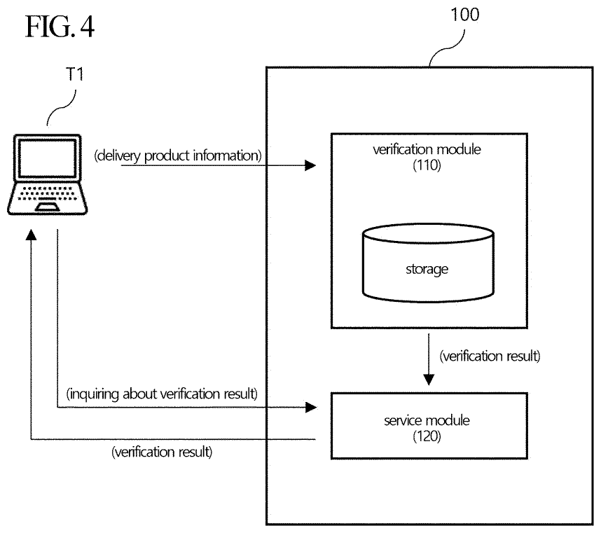

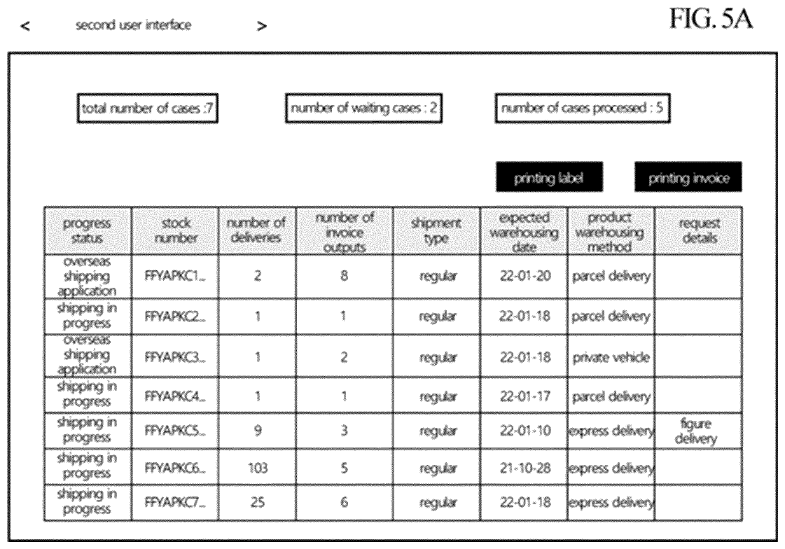

FIG. 4 is a view briefly illustrating a process of processing verification in the exemplary embodiment of the present disclosure.

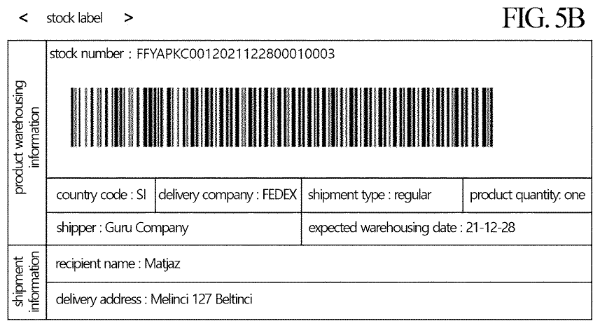

FIG. 5A is a view illustrating a second user interface when the seller checks status of warehoused products in the exemplary embodiment of the present disclosure. FIG. 5B is a view illustrating an example of a stock label in the exemplary embodiment of the present disclosure.

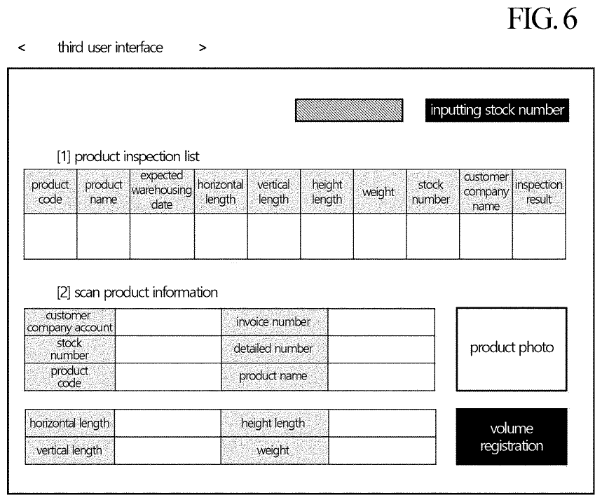

FIG. 6 is a view illustrating a third user interface when a third party shipping service provider inputs inspection information about a volume and weight of a product in the exemplary embodiment of the present disclosure.

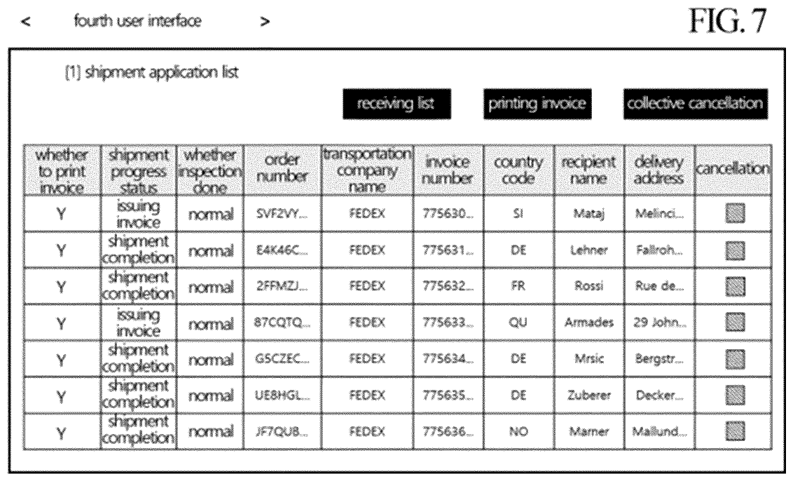

FIG. 7 is a view illustrating a fourth user interface through which the seller inquires shipment status in the exemplary embodiment of the present disclosure.

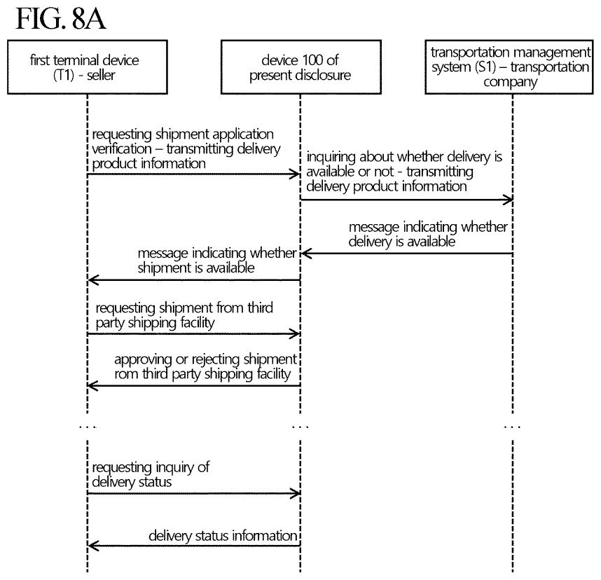

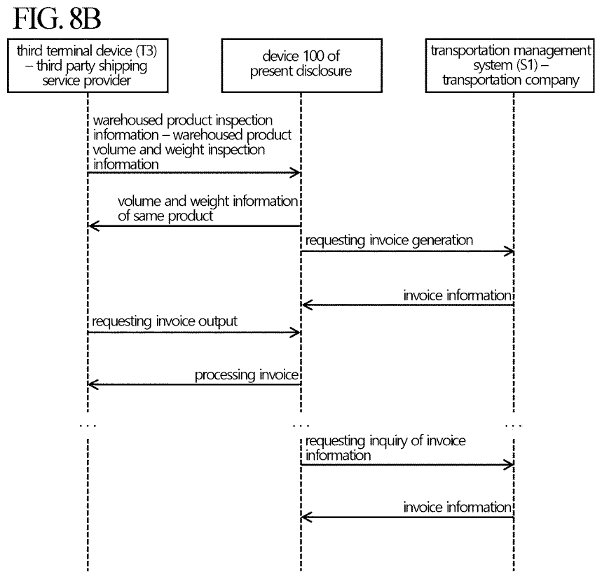

FIG. 8A is a timing diagram illustrating a process of making a shipment application of a product by the seller in the exemplary embodiment of the present disclosure. FIG. 8B is a timing diagram illustrating a process of processing shipment of the product by the third party shipping service provider in the exemplary embodiment of the present disclosure.

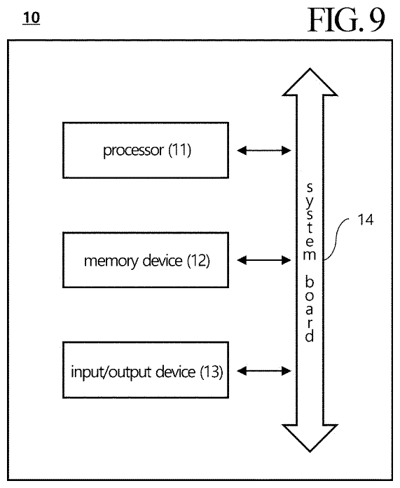

FIG. 9 is a view briefly illustrating a configuration of a computing device in an exemplary embodiment of the present disclosure.

### DETAILED DESCRIPTION OF THE INVENTION

Hereinafter, exemplary embodiments of the present disclosure are described with reference to the accompanying drawings. Advantages and features of the present disclosure and the methods of achieving the same will become apparent with reference to the exemplary embodiments described below in detail in conjunction with the accompanying drawings. However, the technical ideas of the present disclosure are not limited to the exemplary embodiments disclosed below, but will be implemented in a variety of different forms. These exemplary embodiments are provided only to complete the technical ideas of the present disclosure and to completely inform the scope of the present disclosure to those skilled in the art to which the present disclosure pertains, and the technical ideas of present disclosure are only defined by the scope of the claims.

In adding reference numerals to the components of each drawing, it should be noted that the same reference numerals are used to refer to the same components as much as possible even if displayed on different drawings. In the following description of the present disclosure, detailed descriptions of related known functions and components incorporated herein will be omitted when it is determined that the subject matter of the present disclosure may be obscured thereby.

Unless otherwise defined, all terms (including technical and scientific terms) used in the present description may be used in a sense that can be commonly understood by those skilled in the art. In addition, terms defined in the commonly used dictionary are not ideally or excessively interpreted unless specifically defined. The terminology used herein is for the purpose of describing particular embodiments only and is not intended to be limiting of the embodiments of the present disclosure. In the present specification, the singular form also includes the plural form unless otherwise specified in the phrase.

Further, when describing the components of the present disclosure, terms such as first, second, A, B, (a), and (b) may be used. Since these terms are provided merely for the purpose of distinguishing the components from each other, they do not limit the nature, sequence, order, or the like of the corresponding components. When a component is described as being “connected”, “coupled”, or “linked” to another component, that component may be directly connected or linked to that other component. However, it should be understood that yet another component between each of the components may be “connected”, “coupled”, or “linked” to each other.

In the exemplary embodiments of the present disclosure, a “seller” is an individual or organization that sells products and sends the products to a third party shipping service provider in response to orders of buyers. The “buyers” are individuals or organizations that purchase the products sold by the seller. The “third party shipping service provider” is an individual or organization that receives the products from the seller and transfers the products to a transportation company. A “third party shipping facility” is a facility operated by the third party shipping service provider, and is a place where the products sent by the seller are stored. A “transportation company” is an individual or organization that delivers the products to the buyers.

FIG. 1 is a view briefly illustrating a device and other components for processing shipment in a third party shipping service according to the exemplary embodiment of the present disclosure.

The device 100 (hereinafter referred to as “the device of the present disclosure”) for processing shipment in the third party shipping service according to the exemplary embodiment of the present disclosure may be a single computing device or a set of a plurality of computing devices connected to each other through a communication network.

Data may be transmitted or received via a communication network connected to the device 100 of the present disclosure, terminal devices T1 to T3 respectively used by a seller, buyer, and third party shipping service provider, and a transportation management system S1. Each of the terminal devices T1 to T3 is a computing device including a processor, a storage, and an input/output device, and may be, for example, one of a desktop computer, a laptop computer, a smartphone, and a tablet computer. The transportation management system S1 may be a set of a plurality of server computers connected with each other by the communication network.

The seller may access a product trading system (e.g., an online shopping mall) by using a first terminal device T1, register product sales information, and then check product purchase information of buyers. The product purchase information may include product types or product names, product quantities, delivery addresses, recipient names, payment details (i.e., payment methods, payment amounts, payment dates and times, etc.). The seller may sell products by directly building his or her own product trading system, or sell the products by using a product trading system provided by a third party. In addition, the seller may fill out shipment applications by using the first terminal device T1, and the first terminal device T1 may transmit the shipment applications to the device 100 of the present disclosure.

A buyer may access the product trading system by using the second terminal device T2 and then check product sales information. In addition, the buyer may purchase a product in the product trading system by using the second terminal device T2 and check the product purchase information.

The third party shipping service provider may connect to the device 100 of the present disclosure by using the third terminal device T3, and then check information about the products sent by the seller to a third party shipping facility and information about the products shipped to a transportation company. In addition, the third party shipping service provider may request product inspection from or may provide inspection information to the device 100 of the present disclosure by using the third terminal device T3.

The transportation company may use the transportation management system S1 to generate an invoice number for a product to be delivered to a buyer. According to product invoice information, the transportation company may collect the product from the third party shipping facility and then deliver the product to a delivery address of the buyer.

Application software may be installed and executed in the terminal devices T1 to T3 and the transportation management system S1. The application software may execute functions selected by the seller, buyer, third party shipping service provider, and transportation company, and display user interfaces. The application software may be a web browser or a program that implements a client-server architecture.

FIG. 2 is a flowchart illustrating a method for processing shipment in a third party shipping service according to the exemplary embodiment of the present disclosure.

The method for processing the shipment in the third party shipping service according to the exemplary embodiment of the present disclosure (hereinafter the “method for the present disclosure”) may include each of step S1010 of verifying a shipment application, step S1020 of providing product warehousing information, step S1030 of inspecting a warehoused product, and step S1040 of providing shipment information.

In step S1010 of verifying the shipment application, the device 100 of the present disclosure may verify a shipment application received from a terminal device T1 of a seller.

FIG. 3 is a view illustrating a first user interface when the seller submits a shipment application in the exemplary embodiment of the present disclosure.

The device 100 of the present disclosure may transmit, to the first terminal device T1, a web page having the first user interface enabling contents about the shipment application to be input. An application program of the first terminal device T1 may display the first user interface shown in FIG. 3. Alternatively, the application program of the first terminal device T1 may display the first user interface that is programmed.

The seller may input fundamental information in the first user interface. For example, the fundamental information may include: an expected warehousing date (i.e., a date on which a product to be delivered to a buyer will be warehoused at a third party shipping facility operated by a third party shipping service provider), a warehousing center (i.e., a name of the third party shipping facility), a product warehousing method (i.e., whether the product will be warehoused with a vehicle operated by the seller, or with a vehicle operated by an individual or company other than the seller, etc.), a vehicle number (i.e., a license plate number of the vehicle that will transport the product), contact details of a person transporting the product, a loading method (i.e., how the product is packaged), a delivery type (i.e., whether labeled by product or bulk packaged, etc.), and the like.

The seller may input information about the product to be delivered to the buyer in the first user interface. The information about the product to be delivered may include, for example, a product name, an item classification code, a product price, a delivery address, a country of the delivery address, a recipient name, a unit price, a transaction code, etc.

The seller may input information in the first user interface by product to be delivered. Alternatively, the seller may store a plurality of pieces of delivery product information in a file (e.g., storing the delivery product information in a spreadsheet file), and then perform an upload function (i.e., performing collective registration) provided by the first user interface, so as to register the plurality of pieces of delivery product information. Accordingly, cases of large quantities of deliveries, such as delivering the same products to a plurality of buyers, delivering a plurality of products to one buyer, or delivering the plurality of products to the plurality of buyers, may be processed collectively, thereby managing delivery work convenient and increasing processing speed.

The first terminal device T1 may request verification of a shipment application from the device 100 of the present disclosure. The first terminal device T1 may transmit the fundamental information, and may transmit the delivery product information which is input individually or registered collectively as a file to the device 100 of the present disclosure.

The device 100 of the present disclosure may store the shipment application including the fundamental information and the delivery product information, and then verify the shipment application. The verification of the shipment application is to check whether the delivery product information input by the seller is correct or not. The device 100 of the present disclosure may check, for example, whether or not required items specified in an item classification code, a delivery address, a country of the delivery address, a unit price, a transaction code, etc. have been input into the delivery product information.

In addition, the device 100 of the present disclosure may check whether or not the information input into the delivery product information is within a normal range or not. For example, in a case where the item classification code or transaction code is not a defined code, or in a case where the delivery address is an address from a place that does not exist or a place where delivery is unavailable, or in a case where the country of the delivery address is a country that does not exist or a country where delivery is unavailable, or in a case where the unit price is a number out of range, the device 100 of the present disclosure may transmit, to the first terminal device T1, a message indicating that the delivery cannot be made with the delivery product information.

In order to verify the delivery product information, the device 100 of the present disclosure may define and store normal input values for each item included in the delivery product information. For example, predefined item classification codes or transaction codes, deliverable addresses, countries to which delivery is available, unit price ranges, etc. may be stored for reference when verification operations are performed.

FIG. 4 is a view briefly illustrating a process of processing verification in the exemplary embodiment of the present disclosure.

When the seller inputs or registers the delivery product information in the first user interface before the first terminal device T1 transmits the fundamental information and delivery product information to the device 100 of the present disclosure, the device 10 of the present disclosure may verify the received delivery product information and transmit a verification result to the first terminal device T1. In the first user interface, information (e.g., a product name, a delivery address, a country code of the delivery address, a recipient name, etc.) about the product to be delivered and the verification result may be displayed.

In this case, the more information about the product to be delivered, the more time it may take when verification is performed. In addition, when delivery product information is collectively submitted as a large file, or when an operation other than verification is performed, there may also arise a problem that a memory capacity being used exceeds a memory capacity of a computing device. In addition, until the verification is completed, the first terminal device T1 may have to continue to wait for a response from the device 100 of the present disclosure, and in the meantime, a connection between the first terminal device T1 and the computing device may also be lost.

In order to avoid the problems that may arise in such a way, the device 100 of the present disclosure may include a verification module 110 and a service module 120. The verification module 110 may be a computing device for executing a verification operation of a shipment application, or may be a software module that is executed on a computing resource of a cloud service or executed on the device 100 of the present disclosure. The service module 120 may be a computing device for executing operations other than the verification, or may be a software module executed on the device 100 of the present disclosure.

As shown in FIG. 4, the first terminal device T1 may first transmit delivery product information to the verification module 110. Then, a connection between the first terminal device T1 and the verification module 110 may be disconnected, and a connection between the first terminal device T1 and the service module 120 may be maintained.

The verification module 110 may store the received delivery product information. The verification module 110 may include a storage, or may store the delivery product information by using a storage service of the cloud service. The verification module 110 may expand a storage or storage service as required, so as to accommodate a large volume of delivery product information files.

The verification module 110 may verify the received delivery product information. When using the cloud service, the verification module 110 may transmit an event or a trigger to a computing resource (e.g., an app engine that implements serverless architecture) of the cloud service, and the computing resource of the cloud service may verify the delivery product information after being activated by the event or the trigger. Information about verification results obtained by the verification module 110 or computing resource of the cloud service may be stored in a database or a storage built by the service module 120.

While the verification module 110 verifies the delivery product information, the first terminal device T1 may exchange data with the service module 120 without waiting. Accordingly, the connection between the first terminal device T1 and the device 100 of the present disclosure is not disconnected, and thus a seller may input another shipment application or delivery product information by using the first terminal device T1.

The first terminal device T1 may query the service module 120 for verification results at regular time intervals. In a case where the verification module 110 has not completed the verification of the delivery product information, the service module 120 may transmit a message indicating that the verification is in progress to the first terminal device T1.

When the verification of the delivery product information is completed, the verification module 110 may store the verification results in the database or storage of the service module 120. When the cloud service is used, the computing resource of the cloud service may terminate an operation thereof. In addition, the service module 120 may receive a query about the verification results from the first terminal device T1 and then transmit the corresponding verification results back to the first terminal device T1.

During verification or after completing the verification, the device 100 of the present disclosure may transmit the delivery product information to a transportation management system S1. The transportation management system S1 may check whether products are deliverable to a country of a delivery address or to a delivery address for each product included in the delivery product information.

The transportation management system S1 may transmit a message informing that delivery is available to the device 100 of the present disclosure when a product is deliverable, and may transmit a message including contents (e.g. a natural disaster, war, bankruptcy, strike, etc.) of reasons why delivery is unavailable to the device 100 of the present disclosure when a product is undeliverable. The device 100 of the present disclosure may transmit a shipment availability message including whether a transportation company can deliver a product to a delivery address or not to the first terminal device T1 along with verification results of the delivery product information.

In the first user interface, the seller may check the verification results of the delivery product information and whether the transportation company can deliver the product to the delivery address. When the delivery is available, the seller may select a menu for a shipment application of third party shipping facility in the first user interface.

By using a third terminal device T3, a third party shipping service provider may check the shipment application of third party shipping facility received from the seller and select a menu for approval or rejection of the request. The third terminal device T3 may transmit items selected by the third party shipping service provider to the device 100 of the present disclosure, and the device 100 of the present disclosure may transmit the items to the first terminal device T1. In the first user interface, the seller may check whether the third party shipping service provider has approved or rejected shipment to a third party shipping facility, and in response to this, may send the product to the third party shipping facility.

In step S1020 of providing the product warehousing information, the device 100 of the present disclosure may provide status information of products warehoused at the third party shipping facility to the terminal device T1 of the seller.

FIG. 5A is a view illustrating a second user interface when the seller checks status of the warehoused products in the exemplary embodiment of the present disclosure. FIG. 5B is a view illustrating an example of a stock label in the exemplary embodiment of the present disclosure.

The device 100 of the present disclosure may transmit a web page having the second user interface for checking product warehousing status of the products sent to the third party shipping facility by the seller to the first terminal device T1. An application program of the first terminal device T1 may display the second user interface shown in FIG. 5A. Alternatively, the application program of the first terminal device T1 may display the second user interface that is programmed.

In the second user interface, the seller may check, for each case of shipment application, progress status (i.e., contents for each progress stage), a stock number (i.e., a number issued at the time of applying a shipment application), the number of deliveries (i.e., the number of products included in the shipment application), the number of invoice outputs, a shipment type (i.e., whether regular or bulk delivery), an expected warehousing date, a product warehousing method, request details of the seller, etc.

A menu for printing a stock label for each case of shipment application may be displayed on the second user interface. When the seller selects a label output menu after selecting a case of one or more shipment applications, the device 100 of the present disclosure may transmit the stock label having a format as shown in FIG. 5B to the first terminal device T1.

The stock label may display a stock number, a country code of a delivery address, a delivery company, a shipment type, a product quantity, a name of a shipper which is a seller, an expected warehousing date, a recipient name, the delivery address, etc. The stock number may be displayed with a barcode, a QR code, or a code recognizable by a scanning device, along with a number.

In the second user interface, the seller may print a stock label of the product to be delivered and then send the stock label and product to the third party shipping facility operated by the third party shipping service provider. After the product is warehoused at the third party shipping facility, inspection of the product may be performed.

In step S1030 of inspecting the warehoused product, the device 100 of the present disclosure may receive volume and weight inspection information of the warehoused product from the terminal device T3 of the third party shipping service provider.

The terminal device T3 of the third party shipping service provider may include a volumetric device. The volumetric device may scan a product and measure a volume (or lengths in horizontal, vertical, and height directions) and weight of the product.

FIG. 6 is a view illustrating a third user interface when the third party shipping service provider inputs the volume and weight inspection information of the product in the exemplary embodiment of the present disclosure.

The device 100 of the present disclosure may transmit a web page having the third user interface for inputting volume and weight inspection information of a warehoused product to the third terminal device T3. An application program of the third terminal device T3 may display the third user interface shown in FIG. 6. Alternatively, the application program of the third terminal device T3 may display the third user interface that is programmed.

When the volumetric device of the third terminal device T3 scans the product, the volume (or the lengths in horizontal, vertical, and height directions) and weight information of the product may be displayed in scanned product information of the third user interface.

In addition, when the third terminal device T3 scans a barcode, QR code, or code recognizable by a scanning device, which is displayed in a stock label, information such as a customer company (i.e., a seller) account information, an invoice number of the product sent to the third party shipping facility by the customer company, a stock number, a product code, a product name, a photo of the product taken by the scanning device may be displayed on the scanned product information of the third user interface.

When the third party shipping service provider checks a volume (or lengths in horizontal, vertical, and height directions) and a weight, which are displayed on the third user interface and then selects a menu for registering volume, information about the inspected product may be displayed in a product inspection list of the third user interface. The information about the inspected product may include the product code, the product name, a warehousing application date, the product lengths in the horizontal, vertical, and height directions, the weight, the stock number, a customer company name, an inspection result, etc.

The third terminal device T3 may transmit the volume (or the lengths in the horizontal, vertical, and height directions) and weight information of the scanned product to the device 100 of the present disclosure. The device 100 of the present disclosure may store the received information. In addition, the device 100 of the present disclosure may transmit data obtained by processing the volume (or the measured lengths in the horizontal, vertical, and height directions) and weight information measured for each product to the third terminal device T3, so as to allow the third terminal device T3 to obtain the volume and weight information without having to measure the volume (or lengths in the horizontal, vertical, and height directions) and the weight of the same product. The device 100 of the present disclosure and the third terminal device T3 may identify whether products are the same as each other by using their product codes. Accordingly, when the third terminal device T3 transmits the scanned product code to the device 100 of the present disclosure, the device 100 of the present disclosure may provide the volume and weight information of a product having the same product code as the received product code to the third terminal device T3.

In step S1040 of providing the shipment information, the device 100 of the present disclosure may provide status information of the product, which is shipped from the third party shipping facility, to the terminal device T1 of the seller. In addition, the device 100 of the present disclosure may receive invoice information from the transportation management system S1 and then transmit the invoice information to the third terminal device T3.

The device 100 of the present disclosure may transmit a message for requesting generation of an invoice for the product for which inspection has been completed to the transportation management system S1. The message may include the delivery product information of the product for which the inspection has been completed, and may include, for example, the product name, an item classification code, a product price, a delivery address, a country code of the delivery address, a recipient name, a unit price, a transaction code, etc.

In response to the message, the transportation management system S1 may generate invoice information for the inspection-completed product and transmit the invoice information to the device 100 of the present disclosure. The invoice information may include, for example, an invoice number, an invoice number-related code such as a barcode, QR code, or code recognizable by a scanning device, the product name, the item classification code, the delivery address, the country of the delivery address, the recipient name, etc.

The third terminal device T3 may transmit a message for requesting printing of an invoice to the device 100 of the present disclosure. In response to the message, the device 100 of the present disclosure may process the invoice information received from the transportation management system S1 according to a prepared format and then transmit the invoice information to the third terminal device T3. The third terminal device T3 may print the processed invoice by using a printing device, and the third party shipping service provider may attach the printed invoice to the product and ship the product to the transportation company.

The device 100 of the present disclosure may request inquiry of the invoice information for the product for which the inspection has been completed from the transportation management system S1. In response to this request, the transportation management system S1 may transmit the invoice information for the inspection-completed product.

FIG. 7 is a view illustrating a fourth user interface through which the seller inquires shipment status in the exemplary embodiment of the present disclosure.

The seller or the third party shipping service provider may select a menu for inquiring the shipment status of the product in application programs of the terminal devices T1 and T3.

The device 100 of the present disclosure may transmit a web page having the fourth user interface through which the seller or the third party shipping service provider inquires the shipment status of the product to the first terminal device T1 and the third terminal device T3. The application programs of the first terminal device T1 and the third terminal device T3 may display the fourth user interface shown in FIG. 7. Alternatively, the application programs of the first terminal device T1 and the third terminal device T3 may display the fourth user interface that is programmed.

In the fourth user interface, the seller or third party shipping service provider may check, for each product, whether the invoice is printed or not, shipment progress status, whether the inspection is completed or not, an order number, a transportation company name, an invoice number, the delivery address, the country code of the delivery address, the recipient name, etc.

The seller or third party shipping service provider may select one product in the fourth user interface and then select a menu for printing an invoice, so as to print the invoice. When the seller selects one product and then selects a menu for cancellation, the first terminal device T1 may transmit order number information of the product for which the third party shipping service has been canceled to the device 100 of the present disclosure. The third party shipping service provider may use the third terminal device T3 to check the product for which the third party shipping service has been cancelled, and then stop shipping the corresponding product.

The device 100 of the present disclosure may receive delivery status information of shipped product from the transportation management system S1. In addition, the device 100 of the present disclosure may display the delivery status information of the shipped product in a shipment progress status item of the fourth user interface and provide the delivery status information to the first terminal device T1 and the third terminal device T3.

FIG. 8A is a timing diagram illustrating a process of making a shipment application of a product by a seller in the exemplary embodiment of the present disclosure.

Before making the shipment application, the seller may query whether a product is deliverable to a delivery address or not. In this case, a first terminal device T1 of the seller may transmit delivery product information to the device 100 of the present disclosure. The device 100 of the present disclosure may verify a delivery address and make a request to a transportation management system S1, so as to query whether the product is deliverable to the delivery address or not. The transportation management system S1 may transmit a message including whether the product is deliverable to the delivery address to the device 100 of the present disclosure, and the device 100 of the present disclosure may send a message including a verification result and whether the product is deliverable to the delivery address to the first terminal device T1.

In a case where the product is deliverable to the delivery address, the shipment application may be made in advance regardless of a time point when the product is warehoused at a third party shipping facility after the product is shipped. After requesting shipment, the seller may request an inquiry about product delivery status (i.e., before product warehousing at the third party shipping facility, product warehousing in progress, completion of the product warehousing, shipment to the third party shipping facility in progress, completion of the shipment, delivery by a transportation company in progress, completion of the delivery, etc.), and the device 100 of the present disclosure may return the delivery status information about the product to the first terminal device T1 of the seller. That is, since the shipment application may be made asynchronously without waiting for the product to be warehoused at the third party shipping facility and may inquire the delivery status of the product, the seller may send the product more conveniently by using the third party shipping service than using a conventional method.

FIG. 8B is a timing diagram illustrating a process of processing the shipment of the product by the third party shipping service provider in the exemplary embodiment of the present disclosure. When the product is warehoused at the third party shipping facility after the shipment application of the seller is received, the third party shipping service provider may measure a volume and weight of the product by using a third terminal device T3 and send inspection information to the device 100 of the present disclosure. The device 100 of the present disclosure may transmit information about the same product as the warehoused product to the third terminal device T3.

In addition, the device 100 of the present disclosure may transmit a message for requesting generation of an invoice for the product to be shipped to the transportation management system S1, and in response to the message, the transportation management system S1 may transmit invoice information for the product to be shipped to the device 100 of the present disclosure. The third party shipping service provider may request printing an invoice from the device 100 of the present disclosure by using the third terminal device T3, and in response to the request, the device 100 of the present disclosure may process the invoice and send the invoice to the third terminal device T3. The third party shipping service provider may print the invoice from the third terminal device T3, attach the invoice to the product, and then send the product to the transportation company.

In a case where the seller requests an inquiry of delivery status of the product before the product is shipped from the third party shipping facility (i.e., before, during, or completion of product warehousing at the third party shipping facility), the device 100 of the present disclosure may request and receive the delivery status of the product from the third terminal device T3 of the third party shipping service provider, and then transmit the delivery status of the product to the first terminal device T1 of the seller.

In a case where the seller requests an inquiry of delivery status of the product after the product has been shipped from the third party shipping facility, the device 100 of the present disclosure may request and receive the delivery status of the product from a transportation management system of a transportation company, and then transmit the delivery status of the product to the first terminal device T1 of the seller. In a case where the delivery status of the product is not registered in the transportation management system, the product may be in a state of being shipped from the third party shipping facility, and in a case where the delivery status is received from the transportation management system, the product may be in a state of being delivered or in a delivered state.

The third party shipping service provider may perform processing of product warehousing, inspection, and shipment of the product, while asynchronously providing the responses of the delivery status to the first terminal device T1 of the seller.

FIG. 9 is a view briefly illustrating a configuration of a computing device in an exemplary embodiment of the present disclosure.

The computing device 10 includes a processor 11, a storage 12, an input/output device 13, and a system board 14.

The processor 11 performs operations of reading, changing, or generating data used in the exemplary embodiments of the present disclosure. In addition, the processor 11 interprets and processes computer-readable instructions that execute the method for the exemplary embodiment of the present disclosure. The processor 11 may be a microprocessor including: a controller that interprets instructions and generates control signals for execution; an arithmetic and logic unit that executes arithmetic and logical operation instructions; a register that stores a plurality of instructions, a position of a next instruction to be executed, and data to be input or output; a cache memory that temporarily stores data exchanged between the processor 11 and the storage 12; and a system bus, which is a passage through which data moves within the processor 11.

The storage 12 stores data that is processed or input/output within the computing device 10. In addition, the storage 12 stores the computer-readable instructions for executing the method according to the exemplary embodiment of the present disclosure. The storage 12 may include a main storage and an auxiliary storage. The main storage may include a random access storage or a flash memory device. The auxiliary storage may include one or more of a hard disk drive, a solid state drive (SSD), a flash storage, an optical disc drive, and a magnetic tape.

The input/output device 13 receives input of data into the computing device 10 and outputs data to the outside. In addition, the input/output device 13 receives input of the computer-readable instructions that execute the method according to the exemplary embodiment of the present disclosure. The input/output device may include an external input/output terminal and a driver device that processes the external input/output terminal. For example, the external input/output terminal may include a serial port, a parallel port, a small computer system interface (SCSI), a universal serial bus (USB), an IEEE 1394 port, an external serial advanced technology attachment (e-SATA), and a thunderbolt. In addition, the input/output device may include a network interface controller, and the network interface controller may be connected to a local area network (LAN) based on Ethernet in a wired manner, or may be connected to a wireless local area network (WLAN) based on Wi-Fi in a wireless manner.

The system board 14 connects the processor 11, the storage 12, and the input/output device 13 to each other, and provides a path for data processed by the computing device 10. The system board 14 may include an address bus, an instruction bus, a data bus, a chipset device that controls each bus, and a power system.

The system 100 may be connected to a terminal device located outside the system 100, a personal area network (PAN), a local area network (LAN), a metropolitan area network (MAN), and a wide area network (WAN), and may receive data from an external terminal device or transmit data to the external terminal device by using a data communication protocol such as a transmission control protocol/internet protocol (TCP/IP), a server message block (SMB), a common internet file system (CIFS), an network file system (NFS).

Although the exemplary embodiments of the present disclosure have been described above with reference to the accompanying drawings, it will be understood that those skilled in the art to which the present disclosure pertains may implement the present disclosure in other specific forms as well without departing from the technical spirit or essential features thereof. Therefore, the exemplary embodiments described above are to be understood in all respects as illustrative and not restrictive. The scope of protection of the present disclosure should be interpreted by the following claims, and all technical ideas within the scope equivalent thereto should be construed as being included in the scope of rights of the technical ideas defined by the present disclosure.

1. A method for processing shipment in a third party shipping service, the method comprising:
verifying a shipment application received from a terminal device of a seller, wherein the shipment application comprises a plurality of pieces of delivery product information;
providing status information of a product warehoused at a third party shipping facility to the terminal device of the seller;
receiving volume and weight inspection information of the warehoused product from a terminal device of a third party shipping service provider; and
providing status information of the product shipped from the third party shipping facility to the terminal device of the seller;
wherein the verifying of the shipment application checks whether a delivery address is an address from a place that does not exist or a place where delivery is unavailable, and whether a country of the delivery address is a country that does not exist or a country where the delivery is unavailable;
wherein, in the verifying of the shipment application, the terminal device of the seller transmits the delivery product information to a verification module and then disconnects a connection to the verification module,
the verification module verifies the received delivery product information and transmits a verification result to a service module, and
the service module transmits the verification result received by the service module to the terminal device of the seller in response to querying the service module for the verification result at regular intervals;
wherein the verification module transmits an event or a trigger to a computing resource of a cloud service,
the computing resource of the cloud service is operated by the event or the trigger and then verifies the delivery product information, and
the computing resource of the cloud service completes the verification of the delivery product information, transmits the verification result to the service module, and then terminates an operation thereof.

2. (canceled)

3. The method for claim 1, wherein the verifying of the shipment application checks whether designated items among an item classification code, a delivery address, a country of the delivery address, a unit price, and a transaction code are input into the delivery product information.

4. (canceled)

5. (canceled)

6. (canceled)

7. The method for claim 1, wherein the status information of the warehoused product comprises one or more of progress status, a stock number, the number of deliveries, the number of invoice outputs, a shipment type, an expected warehousing date, a product warehousing method, and request details of the seller.

8. The method for claim 1, wherein the receiving of the volume and weight inspection information of the warehoused product provides volume and weight information of the product having a product code that is the same as a product code scanned by the terminal device of the third party shipping service provider.

9. The method for claim 1, wherein the status information of the shipped product comprises one or more of whether an invoice is printed or not, shipment progress status, whether inspection is completed or not, an order number, a transportation company name, an invoice number, a delivery address, a country code of the delivery address, and a recipient name.

10. The method for claim 1, wherein invoice generation is requested from a transportation management system,
invoice information is received from the transportation management system, and
the invoice information is processed and transmitted to the terminal device of the third party shipping service provider.

11. A device for processing shipment in a third party shipping service, wherein a shipment application received from a terminal device of a seller is verified, wherein the shipment application comprises a plurality of pieces of delivery product information,
status information of a product warehoused at a third party shipping facility is provided to the terminal device of the seller,
volume and weight inspection information of the warehoused product is received from a terminal device of a third party shipping service provider; and
status information of the product shipped from the third party shipping facility is provided to the terminal device of the seller,
wherein the verifying of the shipment application checks whether a delivery address is an address from a place that does not exist or a place where delivery is unavailable, and whether a country of the delivery address is a country that does not exist or a country where the delivery is unavailable;
wherein, in the verifying of the shipment application, the terminal device of the seller transmits the delivery product information to a verification module and then disconnects a connection to the verification module,
the verification module verifies the received delivery product information and transmits a verification result to a service module, and
the service module transmits the verification result received by the service module to the terminal device of the seller in response to querying the service module for the verification result at regular intervals;
wherein the verification module transmits an event or a trigger to a computing resource of a cloud service,
the computing resource of the cloud service is operated by the event or the trigger and then verifies the delivery product information, and
the computing resource of the cloud service completes the verification of the delivery product information, transmits the verification result to the service module, and then terminates an operation thereof.
